(19) United States
(12) Patent Application Publication
(10) Pub. No.: US 2026/0280246 A1
(43) Pub. Date: Sep. 17, 2026

(54) Cable Trainer

(71) Applicant: Adrian A. Filip, Knoxville, TN (US)

(72) Inventor: Adrian A. Filip, Knoxville, TN (US)

(21) Appl. No.: 19/077,165

(22) Filed: Mar. 12, 2025

(51) Int. Cl. H02G 3/04

(52) U.S. Cl. CPC H02G 3/0462

(57) ABSTRACT

A cable trainer for enclosing and guiding a path of at least one cable. The cable trainer includes a sleeve and a rod of a malleable material that is affixed to the sleeve and extends the length of the sleeve, The rod is bendable by hand into a shape and retains the shape when released. A closure is affixed to the sleeve and extends the length of the sleeve.

### FIELD

This invention relates to the field of cable management. More particularly, this invention relates to bundling and guiding a path of at least one cable.

### INTRODUCTION

Anyone who has dealt with a few cables knows that they quickly become a tangled mess. Once the tangle of cables has been created, it is daunting to sort it out and improve upon the situation. People in many fields, such as electricians, sound technicians, and network installers to name a few, tackle this problem by imposing order upon the cables before they ever form the mess.

Many of the methods used to keep cables in an ordered manner tend to involve fixing the cables in some way to an external structure that is either provided specifically for—or adapted to—that very purpose. For example, network installers might affix a metal panel with slots through which the cables are run and to which the cables are tied. Electricians might staple or otherwise affix cables to wall studs or top plates. Wherever such structures are not available, the cable chaos tends to return.

What is needed, therefore, as something that tends to reduce the issues such as those introduced above, at least in part.

### SUMMARY

The above and other needs are met by a cable trainer for enclosing and guiding a path of at least one cable. The cable trainer includes a sleeve and a rod of a malleable material that is affixed to the sleeve and extends the length of the sleeve, The rod is bendable by hand into a shape and retains the shape when released. A closure is affixed to the sleeve and extends the length of the sleeve.

In some embodiments according to this aspect of the disclosure, the sleeve is formed of at least one of a fabric and a thermoplastic resin. In some embodiments, the malleable material is formed of at least one of steel, copper, and iron. In some embodiments, the closure is formed of at least one of snaps, mating hook and loop strips, mating magnetic strips, releasable adhesive, permanent adhesive, and ties. In some embodiments, the sleeve is provided on a reel and can be cut to a desired length. In some embodiments, the sleeve is provided in a color that is coded to a type of the cable enclosed. In some embodiments, the sleeve is provided in a selection of differing widths and lengths. In some embodiments, the sleeve is printed with identifiable indicia.

According to another aspect of the disclosure there is described a cable trainer for enclosing and guiding a path of at least one cable. The cable trainer has a sleeve that is a hollow tube with a length and a diameter, and a rod of a malleable material that is both affixed to the sleeve and extends the length of the sleeve. The rod is bendable by hand into a shape and retains the shape when released.

In some embodiments according to this aspect of the disclosure, the sleeve is formed of a thermoplastic resin that shrinks when exposed to a sufficient amount of heat. In some embodiments, the malleable material is formed of at least one of steel, copper, and iron. In some embodiments, the sleeve is provided on a reel and can be cut to a desired length. In some embodiments, the sleeve is provided in a color that is coded to a type of the cable enclosed. In some embodiments, the sleeve is provided in a selection of differing diameters and lengths. In some embodiments, the sleeve is printed with identifiable indicia.

According to yet another aspect of the disclosure there is described a method for enclosing and guiding a path of at least one cable, by providing a sleeve having a length and a width, affixing a rod of a malleable material to the sleeve, where the rod extends the length of the sleeve. The rod is bendable by hand into a shape, and it retains the shape when it is released. The sleeve is wrapped lengthwise around the at least one cable and affixed with a closure that extends the length of the sleeve.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a depiction of a malleable cable trainer for enclosing and guiding a cable along a desired path, according to an embodiment of the present disclosure.

FIG. 2 is a depiction of a malleable cable trainer for enclosing and guiding a bundle of cables along a desired path, according to an embodiment of the present disclosure.

FIG. 3 is a depiction of a malleable cable trainer before it is used for enclosing and guiding a cable along a desired path, according to an embodiment of the present disclosure.

FIG. 4 is a depiction of a malleable cable trainer before it is used for enclosing and guiding a cable along a desired path, depicting a closure according to an embodiment of the present disclosure.

FIG. 5 is a depiction of a malleable cable trainer for enclosing and guiding a bundle of cables along a desired path, with a sleeve formed of a continuous tube, according to an embodiment of the present disclosure.

### DESCRIPTION

With reference now to the drawings, there are depicted all of the claimed elements of the various embodiments, although all claimed embodiments might not be depicted in a single drawing. Thus, it is appreciated that not all embodiments include all of the elements as depicted, and that some embodiments include different combinations of the depicted elements. It is further appreciated that the various elements can all have many different configurations, and are not limited to just the configuration of a given element as depicted. As indicated above, the elements of the drawings as depicted are not to scale, even with respect one to another, and relative size or thickness of one element cannot be determined by the aspect ratios of that element or with reference to any dimension of another element.

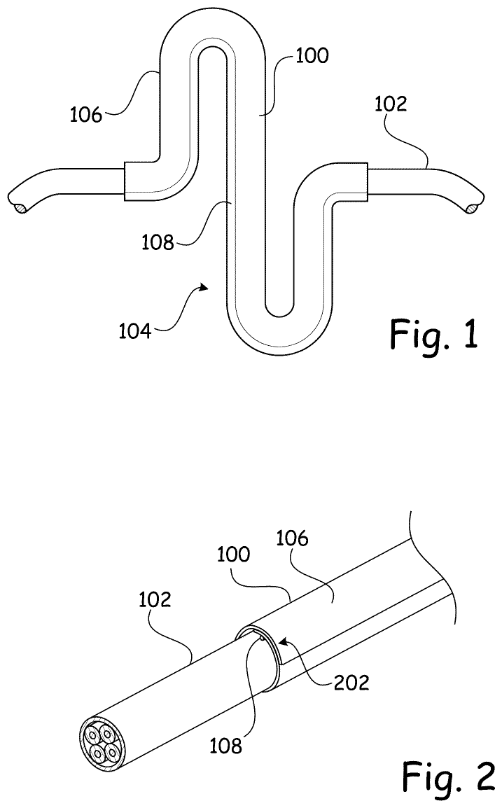

With reference now to FIG. 1, there is a depiction of a malleable cable trainer 100 for enclosing and guiding a cable 102 along a desired path 104, according to an embodiment of the present disclosure. The cable trainer 100 includes a sleeve 106 that wraps around and encloses the cable 102. The cable trainer 100 also includes a malleable rod 108, which can be bent into the shape of the desired path 104 and, once bent into that shape, will not relax and straighten out once again, but instead, will retain the shape of the desired path 104. In this manner, the cable 102 is retained in the shape of the desired path 104.

In various embodiments, the sleeve 106 is formed of at least one of a fabric and a thermoplastic resin. In some embodiments, the malleable rod 108 is formed of at least one of steel, copper, and iron. In some embodiments, the sleeve 106 is provided on a reel and can be cut to a desired length. In some embodiments, the sleeve 106 is provided in a color that is coded to a type of the cable 102 enclosed. In some embodiments, the sleeve 106 is provided in a selection of differing widths and lengths. In some embodiments, the sleeve 106 is printed with identifiable indicia.

With reference now to FIG. 2, there is a depiction of a malleable cable trainer 100 for enclosing and guiding a bundle of cables 102 along a desired path 104, according to an embodiment of the present disclosure. Also depicted in FIG. 2 is an overlapping area of the sleeve 106, in which is disposed a closure 202.

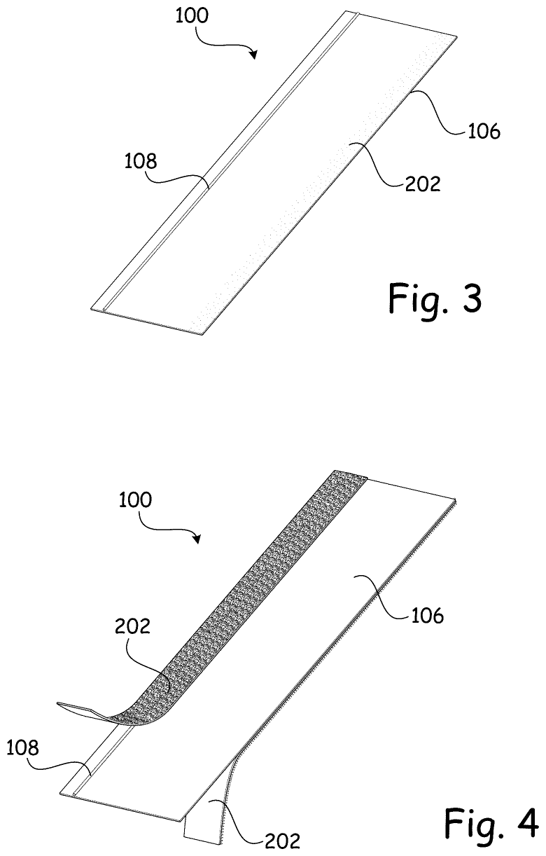

The closure 202 enables the cable trainer 100 to be formed, in one embodiment, as a flat sheet of the sleeve 106 (as depicted in FIG. 3) that can be wrapped around an existing length of cables 102, and then closed using the closure 202 to contain the cables 102 within the cable trainer 100, and along the desired path 104, as defined by the rod 108.

In some embodiments, the closure 202 is formed of at least one of snaps, mating hook and loop strips (as depicted in FIG. 4), mating magnetic strips, releasable adhesive, permanent adhesive, and ties.

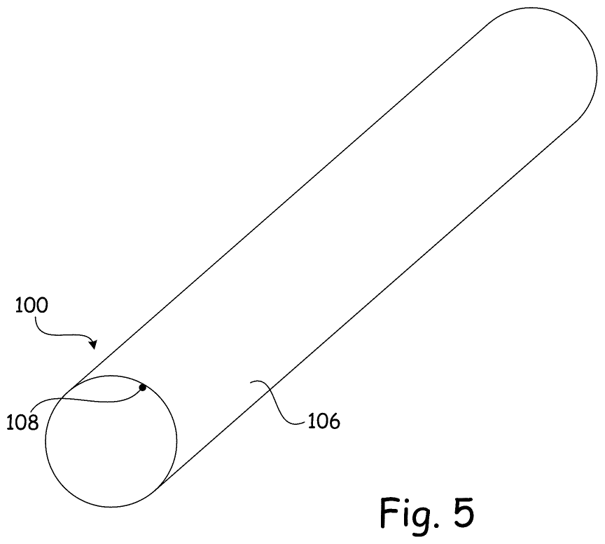

In some embodiments, as depicted in FIG. 5, the sleeve 106 is a hollow tube of a thermoplastic resin, that shrinks against the cables 102 when exposed to a sufficient amount of heat (heat shrink tubing). In other embodiments, the sleeve 106 is formed of a stretchable fabric that is stretched and pulled over the cables 102, and then relaxes into a tighter diameter that holds the cables 102 together. In both embodiments, the malleable rod 108 allows the cable trainer 100 to be formed along the desired path 104.

As used herein, the phrase “at least one of A, B, and C” means all possible combinations of none or multiple instances of each of A, B, and C, but at least one A, or one B, or one C. For example, and without limitation: Ax1, Ax2+Bx1, Cx2, Ax1+Bx1+Cx1, Ax7+Bx12+Cx113. It does not mean Ax0+Bx0+Cx0.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A cable trainer for enclosing and guiding a path of at least one cable, the cable trainer comprising:
a sleeve having a length and a width,
a rod of a malleable material that is affixed to the sleeve and extends the length of the sleeve, such that the rod is bendable by hand into a shape and retains the shape when released, and
a closure that is affixed to the sleeve and extends the length of the sleeve.

2. The cable trainer of claim 1, wherein the sleeve is formed of at least one of a fabric and a thermoplastic resin.

3. The cable trainer of claim 1, wherein the malleable material is formed of at least one of steel, copper, and iron.

4. The cable trainer of claim 1, wherein the closure is formed of at least one of snaps, mating hook and loop strips, mating magnetic strips, releasable adhesive, permanent adhesive, and ties.

5. The cable trainer of claim 1, wherein the sleeve is provided on a reel and can be cut to a desired length.

6. The cable trainer of claim 1, wherein the sleeve is provided in a color that is coded to a type of the cable enclosed.

7. The cable trainer of claim 1, wherein the sleeve is provided in a selection of differing widths and lengths.

8. The cable trainer of claim 1, wherein the sleeve is printed with identifiable indicia.

9. A cable trainer for enclosing and guiding a path of at least one cable, the cable trainer comprising:
a sleeve comprising a hollow tube having a length and a diameter, and
a rod of a malleable material that is affixed to the sleeve and extends the length of the sleeve, such that the rod is bendable by hand into a shape and retains the shape when released.

10. The cable trainer of claim 9, wherein the sleeve is formed of a thermoplastic resin that shrinks when exposed to a sufficient amount of heat.

11. The cable trainer of claim 9, wherein the malleable material is formed of at least one of steel, copper, and iron.

12. The cable trainer of claim 9, wherein the sleeve is provided on a reel and can be cut to a desired length.

13. The cable trainer of claim 9, wherein the sleeve is provided in a color that is coded to a type of the cable enclosed.

14. The cable trainer of claim 9, wherein the sleeve is provided in a selection of differing diameters and lengths.

15. The cable trainer of claim 9, wherein the sleeve is printed with identifiable indicia.

16. A method for enclosing and guiding a path of at least one cable, the method comprising the steps of:
providing a sleeve having a length and a width,
affixing a rod of a malleable material to the sleeve that extends the length of the sleeve, such that the rod is bendable by hand into a shape and retains the shape when released, and
wrapping the sleeve lengthwise around the at least one cable and affixing the sleeve around the at least one cable with a closure that extends the length of the sleeve.

17. The cable trainer of claim 16, wherein the sleeve is formed of at least one of a fabric and a thermoplastic resin.

18. The cable trainer of claim 16, wherein the malleable material is formed of at least one of steel, copper, and iron.

19. The cable trainer of claim 16, wherein the closure is formed of at least one of snaps, mating hook and loop strips, mating magnetic strips, releasable adhesive, permanent adhesive, and ties.

20. The cable trainer of claim 16, wherein the sleeve is provided on a reel and can be cut to a desired length.
